(19) United States
(12) Patent Application Publication
(10) Pub. No.: US 2020/0342017 A1
(43) Pub. Date: Oct. 29, 2020

(54) SYSTEM AND METHOD FOR MANAGING RELATED FEEDBACK

(71) Applicant: MICROSOFT TECHNOLOGY LICENSING, LLC, Redmond, WA (US)

(72) Inventors: Eric J. GRUBER, Redmond, WA (US); Aaron T. H. KIM, Seattle, WA (US)

(73) Assignee: MICROSOFT TECHNOLOGY LICENSING, LLC, Redmond, WA (US)

(21) Appl. No.: 16/393,869

(22) Filed: Apr. 24, 2019

(51) Int. Cl. G06F 16/33; G06F 16/338; G06F 16/332

(52) U.S. Cl. CPC G06F 16/3344; G06F 16/3326; G06F 16/338

(57) ABSTRACT

A message content management system and method for automatic query generation and execution of related feedback. A reviewer of a message or reporting event can desire access to other reports that are similar in topic or content. The system is configured to automatically determine the terms that are most likely to be of relevance in identifying the overall topic of the original message. The system can then generate and execute a query directed to a database based at least in part on these relevant terms. The resulting related messages can be automatically displayed to the reviewer. This system can increase reviewer efficiency with respect to addressing and responding to incoming messages as well as allow the reviewer to more readily monitor software issues and bugs.

### BACKGROUND

It is generally understood that computer software will remain likely to contain errors and exhibit other unexpected and undesirable behavior. In order to develop and maintain useful, high-quality software products while minimizing errors and other problems, it is essential that software developers receive informative feedback from users. The task of collecting and analyzing sufficiently-detailed user experience information in order to make appropriate improvements to software is especially challenging in large-scale projects involving a widely-dispersed user base.

Various utilities and access points have been designed to facilitate submission of reports on bugs and other issues from software customers and users to developers. However, software vendors and their developer-reviewers can find that manually collecting the necessary information together can be challenging and time consuming. As customer feedback is submitted, vendors wish to address problems quickly and fully to establish stronger customer loyalty and satisfaction. It is well know that the ease in which user interactions and troubleshooting is facilitated with the device or software will affect customer perception of the product. For example, frustrated consumers will be unlikely to make future purchases.

However, particularly in the cases of software that has a recurring issue or error, the ability to readily ascertain or track related customer feedback can be challenging and at times obscured. Thus, there remain significant areas for new and improved ideas for the efficient availability of locating messages from users that enable developers to review and react effectively to customer feedback.

### SUMMARY

A data processing system, in accordance with a first aspect of this disclosure, includes a processor and one or more computer readable media. The computer readable media include instructions which, when executed by the processor, cause the at least one processor to receive, from a first client system, a first message, and to store the first message in a message database, where the message database includes a plurality of messages, and each message in the message database includes its own set of terms, the set of terms for the first message including a first term and a second term. In addition, the instructions cause the processor to generate and assign a relevance score for each term in the first message based on at least a relative frequency and significance of the term as compared with each set of terms for some or all of the other messages stored in the message database, the first term being assigned a greater relevance score than the second term. The instructions also cause the processor to automatically compose a first query that includes at least the first term, and automatically execute the first query against a group of messages in the message database. The instructions then cause the processor to identify, based on the first query, first resultant messages of the group of messages that include at least the first term, the first resultant messages including a second message, and present, via a display associated with a second client system, the first resultant messages including the second message.

A method, in accordance with a second aspect of this disclosure, includes a first step of receiving, receiving, from a first client system, a first message, and a second step of storing the first message in a message database, the message database including a plurality of messages, where each message in the message database includes its own set of terms, and the set of terms for the first message including a first term and a second term. A third step includes generating and assigning a relevance score for each term in the first message based on at least a relative frequency and significance of the term as compared with each set of terms for other messages stored in the message database, the first term being assigned a greater relevance score than the second term. In a fourth step, the method includes automatically composing a first query that includes at least the first term, followed by a fifth step of automatically executing the first query against a group of messages in the message database. A sixth step includes identifying, based on the first query, first resultant messages of the group of messages that include at least the first term, the first resultant messages including a second message, and a seventh step of presenting, via a display associated with a second client system, the first resultant messages including the second message.

A computer readable medium, in accord with a third aspect of this disclosure, includes instructions stored therein which, when executed by a processor, cause the processor to perform operations that include receiving, from a first client system, a first message, storing the first message in a message database, where the message database includes a plurality of messages, and each message in the message database includes its own set of terms, the set of terms for the first message including a first term and a second term. Furthermore, the instructions cause the processor to generate and assign a relevance score for each term in the first message based on at least a relative frequency and significance of the term as compared with each set of terms for other messages stored in the message database, the first term being assigned a greater relevance score than the second term. In addition the instructions cause the processor to automatically compose a first query that includes at least the first term, and automatically execute the first query against a group of messages in the message database. The instructions further cause the processor to identify, based on the first query, first resultant messages of the group of messages that include at least the first term, the first resultant messages including a second message, and present, via a display associated with a second client system, the first resultant messages including the second message.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 illustrates an implementation of a message submission and automatic query execution environment;

FIG. 2 is a system diagram illustrating an implementation of a message content management system configured to find and display messages related to a first (original) message;

FIGS. 3A and 3B are an example of an end-user submitting a reporting message for a software issue;

FIG. 4 is an implementation of a computing device display presenting a message reviewing interface;

FIG. 5 is an implementation of a message content with a plurality of terms distinguished for purposes of illustration;

FIG. 6 is an implementation of an automated query generation flow in which terms are lemmatized and submitted to a query generator;

FIG. 7 is an implementation of a display presenting an interface with a message results listing;

FIG. 8 is an implementation of a process of generating a query for finding and providing related messages to a reviewer;

FIG. 9 is a flow diagram of an implementation of a method of determining a relevance of terms in a message and automatically generating and executing a query based in part on the more relevant terms;

FIG. 10 is a block diagram of an example computing device, which may be used to provide implementations of the mechanisms described herein; and

FIG. 11 is a block diagram illustrating components of an example machine configured to read instructions from a machine-readable medium.

### DETAILED DESCRIPTION

In the following detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings.

The following implementations introduce a message content management system and process for facilitating awareness of related or similar messages for reviewers of said messages. A content developer or software engineer may review user feedback with respect to an application to determine how such programs may be improved for subsequent release, or in order to address ongoing issues in that application. However, such reviewers may not have easy access to feedback stores.

The identification and presentation of related message events from users can provide a more precise and richer understanding of which issues are recurring, as well as awareness of common contextual factors that are associated with these issues. In addition, such a tool can allow the developer or other message content reviewer to remain cognizant or ‘on the same page’ with respect to the frequency of a software-related problem as well as ready access to previous responses provided to other users experiencing similar issues. In particular, implementations of the disclosed systems can offer reviewers a straightforward process by which to more efficiently identify messages that are of particular significance to them. As an example, the system may offer the reviewer an option to quickly access or view a list of recently submitted message that have been added to a database, expediting a reviewer's ability to comprehend the operational event being described in a broader context. These lists can in some implementations be the product of large-scale computational metrics for processing terms in the language of the message or other document. In another example, a reviewer can access a message and target and select a portion of content within the larger message that directly interests them and view the feedback similar to only that portion. This can decrease the time that would otherwise be expended in navigating among the numerous layers of messages and responses that have been made with respect to a particular issue. For example, the presentation of the more relevant or similar messages can be configured to facilitate an improved review insight and knowledge regarding the specific problem being described. This lessens the burden of time and mental energy of reviewers who traditionally identified these messages by manually defined search queries, or a cumbersome navigation through a group of messages until they find the one that is helpful. In addition, reviewers can more readily work out when a problem first began affecting consumers. Such tools can provide reviewers with the ability to more clearly distinguish between issues that are more prevalent from those issues that are “one-on” or relatively infrequent, as well as quickly become familiar with patterns in the issue or capture information needed for development of a solution to the problem.

In general, an end-user (also referred to as a reviewer) is one who reviews, manages, or otherwise access pieces of electronic content, including a database or other data store for feedback-based message content associated with a software (also referred to as program or software program). An end-user includes a user of the disclosed systems. Furthermore, the term “software application”, “software”, “program”, or “application” can refer to a computer program that performs useful work, generally unrelated to the computer itself. Some non-limiting examples of software applications include word processors, productivity applications, spreadsheets, accounting systems, and telecommunication programs, as well as gaming software, utility and productivity tools, mobile applications, presentation graphics, and other productivity software. In addition, the software can be provided as a client-based application (locally) or a cloud based interface or system, or combinations thereof.

Furthermore, the term “message” or “feedback” comprises digital data or electronic content that may be presented to the end-user (e.g., visually or audibly presented), including but not limited to an electronic document, a media stream, a web page, a hypertext document, an image, digital video or a video recording, digital audio or an audio recording, animation, a markup language document, such as a HyperText Markup Language (HTML) or eXtensible Markup Language (XML) document, a form having blank components to accept entered data, or data describing the application of a GUI, and other digital data. As an example, this electronic content may include spreadsheets, presentations, or other digital-based media. Typically the message will include text-based electronic content.

Furthermore, within these messages, the electronic content can be understood to include elements that will be referred to as message terms, or more simply, terms. A “message term” can be understood to include any part of electronic content that is defined or discernable as a part. For example, a message term may be automatically discerned from a characteristic of the content portion itself, and will in most cases be distinguished as a word or alphanumeric label or other file format designation or metadata. A term may be manually defined by a reviewer or end-user. Examples of terms include portions or pieces of electronic text or other material within an electronic document, comments, dynamic content in the form of portions of media streams, such as sections of digital video or frames or sets of frames of digital video or digital audio, dynamic content in the form of segments or frames of animations, electronic forms, form templates, form elements, form data, actuatable element specifications or executable instructions, and various elements presentable or accessible by reviewers within electronic content, including instances of scripted and non-scripted dynamic content and the like. In addition, in many cases as well as for purposes of the claims, a message term can be based on or extend to include the lemma of the portion or electronic content being cited. For example, the message term can comprise the lemma of a corresponding selected content portion or word. In other words, in some implementations, message terms encompass or refer to a more basic citation form of a word for the purposes of language or dictionary entries. The form that will be utilized will depend greatly on the specifics of the language that was used in the message as well as the type of text in question. Typically, such lemmas reflect a word's most morphologically simple form, from which other related words extending from this form can be derived.

In different implementations, once a customer or other user of a software submits a message to a message content management system, the message may be stored in one or more associated message databases. The message may then be made available for viewing by a reviewer in a substantially real-time manner, or there may be a delay as the message is processed or incorporated into the database before it is accessible by others. In some implementations, the messages may be automatically added to the database and also codified for ready use by a query or search engine. It should be understood that messages can include user-created text-based content, as well as corresponding metadata (e.g., information about the message, as well as about the source of the message, corresponding operational event data).

As will be described below, the proposed system provides a convenient mechanism by which reviewers can more precisely and/or meaningfully access related messages as well as address the issues communicated by the content of these messages, providing reviewers with a more comprehensive and intuitive sense of the software feedback and development process. This in turn can improve the management of software issues and customer needs as a whole and facilitate a more natural and effective workflow. These systems and methods can reduce the demands on members of a software development team, which can help foster relationships between users and software vendors, as well as increase quality of the software end-product.

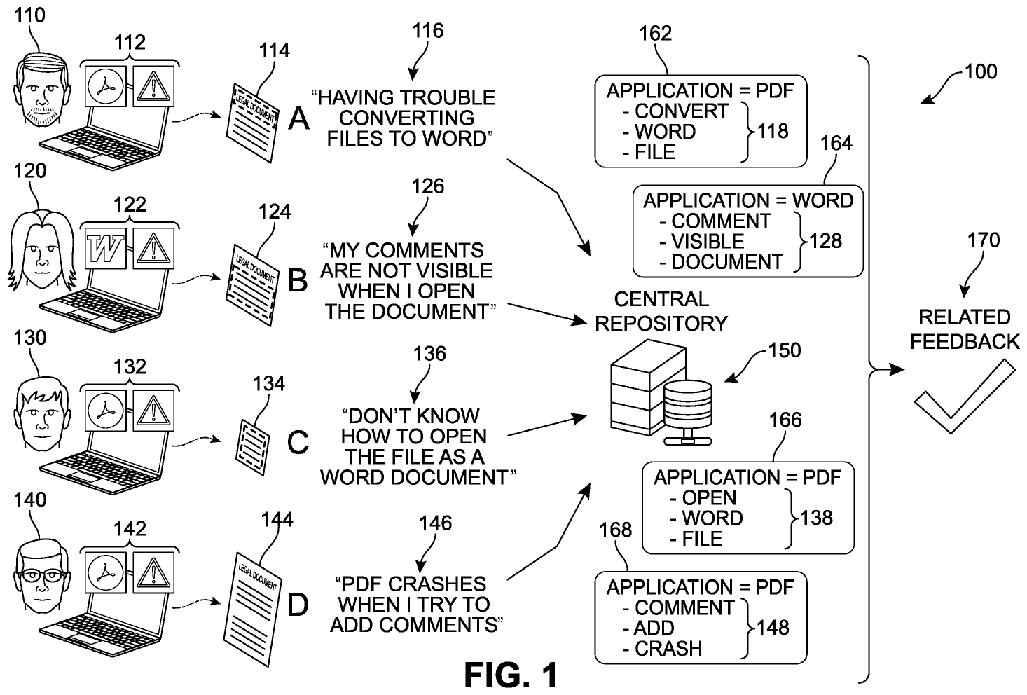

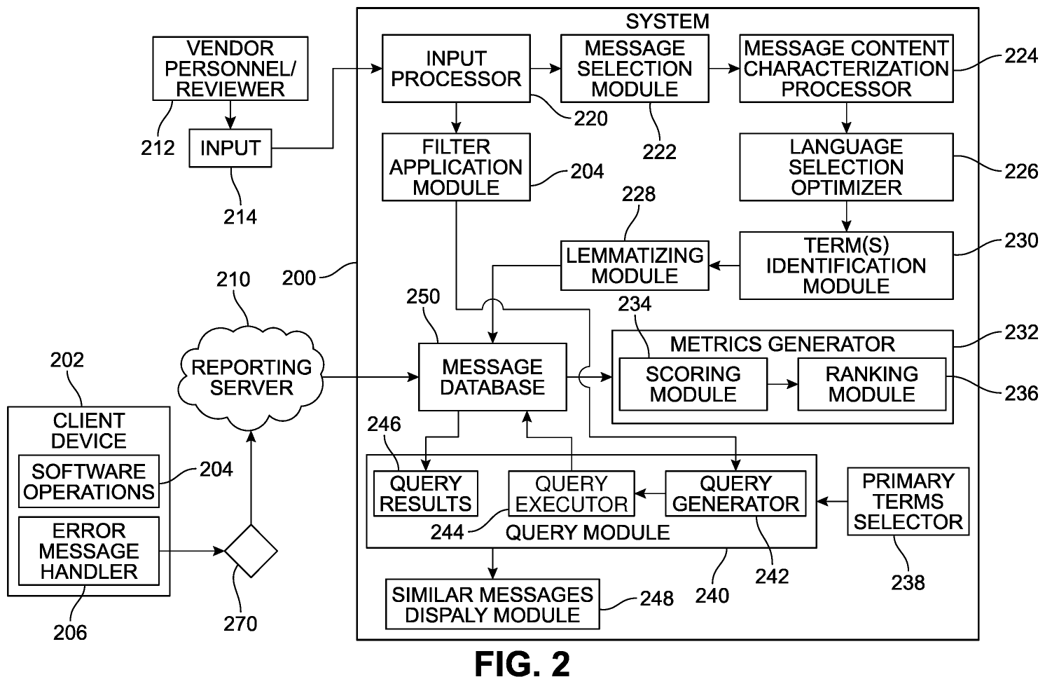

In order to better introduce the systems and methods to the reader, FIG. 1 presents an example of a representative message content management environment (“environment”) 100 for implementing a related-messages identification system (illustrated schematically in FIG. 2). In different implementations, the environment 100 can include a plurality of computing device users, also referred to here as consumers or customers. For example, a first consumer 110, a second consumer 120, a third consumer 130, and a fourth consumer 140 are depicted in FIG. 1. One or more consumers can interact with or manipulate data presented via a user device. In this case, each user is accessing a software program on separate computing devices. The devices can be linked via a network to the vendor's local data repositories (e.g., database 150). As the consumers interact with and/or perform work using their selected program, they may sometimes experience ‘bugs’ or other problems.

In this example, the first consumer 110 is shown accessing a first software 112 on their client device, and in response to a troublesome user experience, has submitted a first message 114 comprising a first message content 116 (“Having trouble converting files to word”). This user experience can generally refer to user reactions or responses to a software issue or ‘bug’, such as an error, flaw, failure, or fault in a computer program or system that causes it to produce an incorrect or unexpected result or to behave in unintended ways. If such bugs occur, the person finding the issue or ‘bug’ (here, the consumer) may be provided with an opportunity to report or document the issue (via a message) and send this notice of the issue to a resource responsible for fixing the reported error or failure. Typically (or ideally), the message might explain how the product is broken, and what was the desired result, although this is not always or even commonly the case. In different implementations, users may be offered a blank space in which to input text describing the problem, while in other implementations, there may be a plurality of fields with specific pre-generated choices to identify and categorize the issue, while in other cases there may be a mixture of these. Similarly, the second consumer 120 is shown accessing a second software 122 on their client device, and in response to a negative user experience, has submitted a second message 124 comprising a second message content 126 (“My comments are not visible when I open the document”). The third consumer 130 is shown accessing a third software 132 on their client device, and in response to their negative user experience, has submitted a third message 134 comprising a third message content 136 (“Don't know how to open the file as a word document”). Finally, the fourth consumer 140 is shown accessing a fourth software 142 on their client device, and in response to an error, has submitted a fourth message 144 comprising a fourth message content 146 (“PDF crashes when I try to add comments”).

In different implementations, as various messages are submitted to the vendor data repository, such as database 150, reviewers on the ‘other’ end of the process can desire access to specific types of messages, or messages containing particular content. In some implementations, a reviewer may opt to initiate an automated query direct to the messages stored in database 150. In the example of FIG. 1, a plurality of terms are selected, designated, or otherwise identified with respect to the message contents for each message. For the first message content 116, a first set of terms 118 is identified, for the second message content 126 a second set of terms 128 is identified, for the third message content 136 a third set of terms is identified 138, and for the fourth message content 146 a fourth set of terms is identified 148. It can be observed that for purposes of this example, the sets of terms respectively include lemmatized versions of the selected words. Thus, in some implementations, the terms collected can be configured to reflect their simplified or linguistically basic form.

More specifically, it may be seen in FIG. 1 that while the first message content 116 includes, among others, the words “Converting”, “Word”, and “Files”, the first set of terms 118 translates or lemmatizes the word “Converting” to “Convert” and “Files” to “File”, and maintains the term “Word”, which is already in its lemmatized form. Similarly, the second message content 126 includes, among others, the words “Comments”, “Visible” and “Document”, and the second set of terms 128 produces the word “Comment” from “Comments” while maintaining the terms “Visible” and “Document”. The third message content 136 includes, among others, the words “Open”, “Word”, and “File”, which remain unchanged in the third set of terms 138. Furthermore, the fourth message content 146 includes, among others, the words “Comments”, “Add”, and “Crashes”, and the fourth set of terms 148 lemmatizes “Comments” to “Comment” and “Crashes” to “Crash”, while maintaining “Add” in its original form.

It should be understood that the selection of the specific words in each message's set of terms is not necessarily random. Instead, as will be discussed in greater detail below, various computational metrics and/or machine learning algorithms can be applied to choose one or more words from the message content that are predicted or calculated to more closely distinguish the primary purpose of the message.

Furthermore, in different implementations, the messages can be associated with or include one or more items of metadata. For example, each message conveyed to the database 150 and can be linked or otherwise contain metadata that provides context for the message and the software that is being referenced. In FIG. 1, a first metadata item 162 reflects that the application associated with the cited issue in the first message 114 is a PDF-based-type application. Similarly, a second metadata item 164 identifies the application as a Word®-document-based application for the second message 124, and a third metadata item 166 identifies the application as another PDF-based-type application for the third message 134. A fourth metadata item 168 identifies the corresponding application as a PDF-based-type application for the third message 144. While the metadata items in this case are directed to identification of the software, as will be discussed below, the messages can be associated with a wide range of metadata types and categories that can be of great use to reviewers. Furthermore, in some implementations, these items can be selected or added to the query to create filters during a search for related messages. In some implementations, the metadata can be automatically generated based on the client device used to submit the message, while in other implementations, a user can submit additional or supplementary input that can provide such details.

In general, when a reviewer accesses the database 150, they may be able to view the messages and information about the messages, and/or options or tools that can be used in association with the message and generating a response. As reflected at a high-level in FIG. 1, for example in response to a request or selection or other type of triggering event by a reviewer to access similar feedback 170, the sets of terms for each message can be used to cross-reference or otherwise collect together messages with similar content or issues. This process will be discussed in more detail below with reference to FIGS. 2-9.

Referring now to FIG. 2, an example of a representative architecture for a message content management system (“system”) 200 is depicted. In different implementations, the proposed systems include provisions for accessing different stores of information in order to identify feedback events associated with a high likelihood of being relevant or similar to a reviewer and/or presenting various user interfaces for sharing this information. In some implementations, the process of determining the relevance of a particular message event can be based on the contents of the initial or original message (the message for which similar messages are sought). The system 200 can be configured to perform a series of steps to determine whether a specific message or messages have a high likelihood of being relevant to a user.

In FIG. 2, an end-user's client device 202 and a reviewer 212 are depicted. The end-user, via client device 202, can interact with features during software operations 204. In some cases, an error may occur, and the end-user may produce or otherwise submit an error message, for example via an error message handler 206. This message 270 can be conveyed to or received by a message database (“database”) 250 associated with the system 200 via reporting server 210 such as, but not limited to, a network connection or cloud service or other telecommunications link. In some implementations, the message can be likened to an operational data report, and can convey information beyond that directly composed by the end-user. In addition, it should be understood that while a generalized message database 250 is depicted here for purposes of simplicity, in other implementations there may be multiple storage components. For example, in one implementation, a storage resource can be automatically populated by messages as they arrive in the system 200. In another implementation, messages can be automatically distributed to various vendor personnel (such as reviewer 212) for review as they arrive from the customer.

In different implementations, the system 200 can include provisions for enabling access to messages in the database 250. The reviewer 212 can in some implementations provide various user inputs 214 to an input processor 220. These inputs can trigger various types of access to the database and enable selections of particular messages (see message selection module 222), such as (for example) the message 270. In some implementations, input 214 can also correspond to a request for presentation of similar or related messages, or messages that are relevant in the context of the selected (currently viewed) message.

In response to such a request, or in some cases, following the opening or activation of an interface in which the related feedback is presented by default, the message 270 can be submitted for processing to a message content characterization processor 224. An initial analysis of the message content can occur, and be conveyed to a language selection optimizer 226, which can identify key terms that most likely represent the issue. In some implementations, this can involve identification of extraneous or unnecessary words or phrases, such as but not limited to “a”, “and”, “the”, words that link sentences in grammar, (i.e., transition words) as well as other grammar-based articles for conveyance to a term(s) identification module 230. In this stage, the message content may be trimmed to include only substantive (versus non-substantive) words and thereby produce or generate a plurality of message terms for receipt by an optional lemmatizing module 228.

In some implementations, the lemmatizing module 228 can be configured to transform the received plurality of terms from the term(s) identification module 230 to the version of the word that would appear at the head of a dictionary entry for the word. As noted earlier, lemmatizing can allow a term to take on its broadest expression, and ensure all variations of the term can be matched or detected during the search. These lemmatized terms are transmitted to a metrics generator 232. It can be observed that the metrics generator 232 operates in conjunction with the message database 250, which provides the necessary comparison context or referential backdrop. In different implementations, the metrics generator 232 can use one or more scoring tools (see scoring module 234) to compare the plurality of terms against the messages available in the message database 250. The results of such scoring can be submitted to a ranking module 236 for identifying and/or determining the most significant, important, relevant, or otherwise meaningful set of terms that can represent the message 270. In some implementations, each term of the plurality of terms can be assigned a weight based on its relative calculated importance. These weighted terms can be conveyed to a primary terms selector, which can select a smaller number of terms from the plurality of terms based on their relatively higher ranking. In some implementations, the primary terms selector can designate or select only the top ranked term, and in other implementations, the primary terms selector can select at least the top ranked term as well as one or more of the second highest ranked term, third highest ranked term, fourth highest ranked term, and so forth, in ranked order. In one implementation, the primary terms selector may be optional, and all terms, along with their respective weights, may be submitted to a query module 240.

In different implementations, the system 200 can apply various techniques to identify keywords that are most likely to be descriptive of the content in the messages. One exemplary approach for identifying keywords that may be implemented by system 200 is computing term frequency-inverse document frequency (TF-IDF). This metric, described generally, combines two different metrics (a first metric and a second metric) to ascertain a score for a keyword in a document. The first metric can refer to the frequency of the keyword in the message that is being analyzed. For example, if the keyword occurs multiple times in the message content, then this keyword may be highly descriptive of the purpose (the topic) of the message. The second metric is referred to as inverse document frequency, which indicates, for a corpus of messages that includes the original message, a number of messages that include the keyword. As an example, if every message in the message corpus includes the keyword, then such keyword is likely not descriptive of the purpose of any of the messages. In other words, as such keyword occurs in most messages, it is therefore not descriptive of a purpose or intent of any of the messages).

In different implementations, computing TF-IDF for each term in each message of a relatively large corpus of messages can typically comprise a task that is undertaken by use of algorithms that have been developed with the ability to leverage parallel processing capabilities of distributed computing environments. Thus, the task of computing TF-IDF, for each keyword/message combination in a relatively large corpus of messages, can in some cases be distributed across several computing nodes, where the several computing nodes perform certain operations in parallel. Implementations of the present disclosure, and in particular other metric scoring and ranking techniques, can make use of any of the features, systems, components, devices, and methods described in U.S. Patent Publication Number 2013/0346424 to Zhang et al., published Dec. 26, 2012 and titled “Computing tf-idf values for terms in documents in a large document corpus”; U.S. Pat. No. 7,653,627 to Li et al., issued Jan. 26, 2010 and titled “System and method for utilizing the content of an online conversation to select advertising content and/or other relevant information for display”; U.S. Pat. No. 7,296,011 to Chaudhuri et al., issued Dec. 26, 2012 and titled “Efficient fuzzy match for evaluating data records”; U.S. Pat. No. 7,761,447 to Brill et al., issued Jul. 20, 2010 and titled “Systems and methods that rank search results”; U.S. Pat. No. 6,795,820 to Barnett, issued Sep. 21, 2004 and titled “Metasearch technique that ranks documents obtained from multiple collections”; and U.S. Pat. No. 9,727,782 to Ravid et al., issued Aug. 8, 2017 and titled “Method for organizing large numbers of documents” the disclosures of each of which are herein incorporated by reference in their entirety.

Once the primary terms have been selected and/or lemmatized, an automated query generator 242 may be triggered based on at least the identification and weights of the primary terms. In some implementations, the query generator 242 may also incorporate one or more filters, which can narrow or limit the landscape of messages that are targeted by the query. These filters can comprise specified tags or labels associated with the message. In some implementations, the filter selections can be based on input 214 by the reviewer 212, which can be received by a filter application module 202 for submission to the query generator 242. In other implementations, the filter(s) can be default search parameters applied automatically by the system during any search. Some of these filters can make reference to metadata associated with the message, including but not limited to (1) operating system, (2) platform, (3) product or software, (4) software version, (5) intended audience for software and/or message content, (6) message creation date (e.g., to search only those messages created within a specified period of time before and/or after the creation of the currently viewed message), (7) other messages by the same end-user, (8) device type, and/or other message properties.

In different implementations, the automatically generated query can be provided to a query executor 244, which initiates the search, with reference to the message database 250. The results of the query (if any) are obtained by query results 246, which can be configured for display to the reviewer via a similar messages display module 248. In some implementations, the results can be displayed in an order as specified by the system or reviewer; for example, the list may be ordered by most-recent, most-similar, alphabetical order by subject line, or other “Sort By” selections. It should be understood that the resultant messages that are found by the system can include references to the lemmatized term, as well as any extensions of the term (e.g., crash being extended into crashes, crashed, crashing, etc.) per the rules of language being applied (e.g., English, French, Spanish, or any other language).

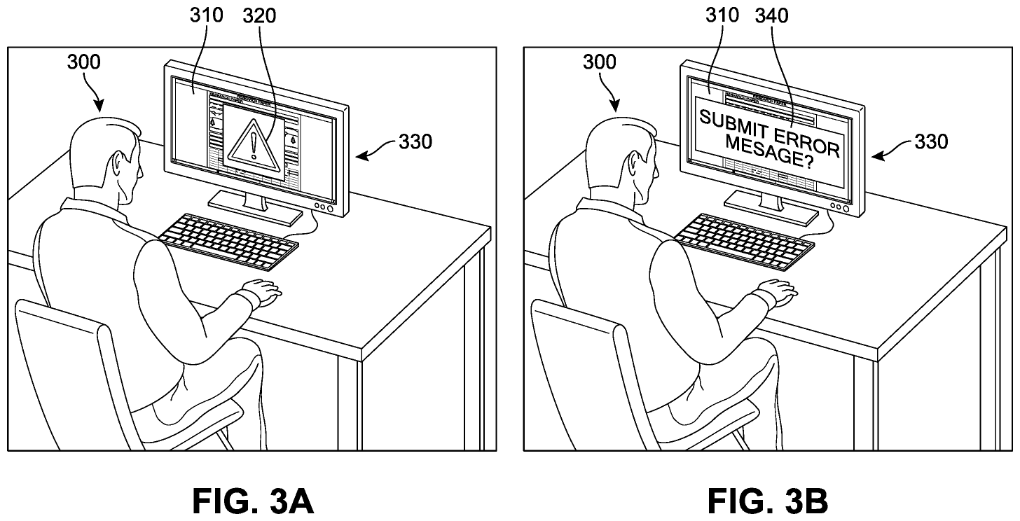

For purpose of clarity for the reader, FIGS. 3A-8 present a sequence illustrating an example of the processes disclosed herein. In FIGS. 3A and 3B, one implementation of an error message reporting event mechanism is depicted with reference to an end-user 300. As shown in FIG. 3A, the end-user 300 can access a software 310 via a client device 330. In some implementations, the end-user 300 may initiate a pattern of activity within the software 310 that leads to an error message 320, or some other issue that is troublesome to the user. In FIG. 3B, the software 310 offers the end-user 300 an opportunity 340 to submit an error message. In different implementations, the end-user 300 may personalize or otherwise approve the content of the error-message and submit it to the vendor site for review.

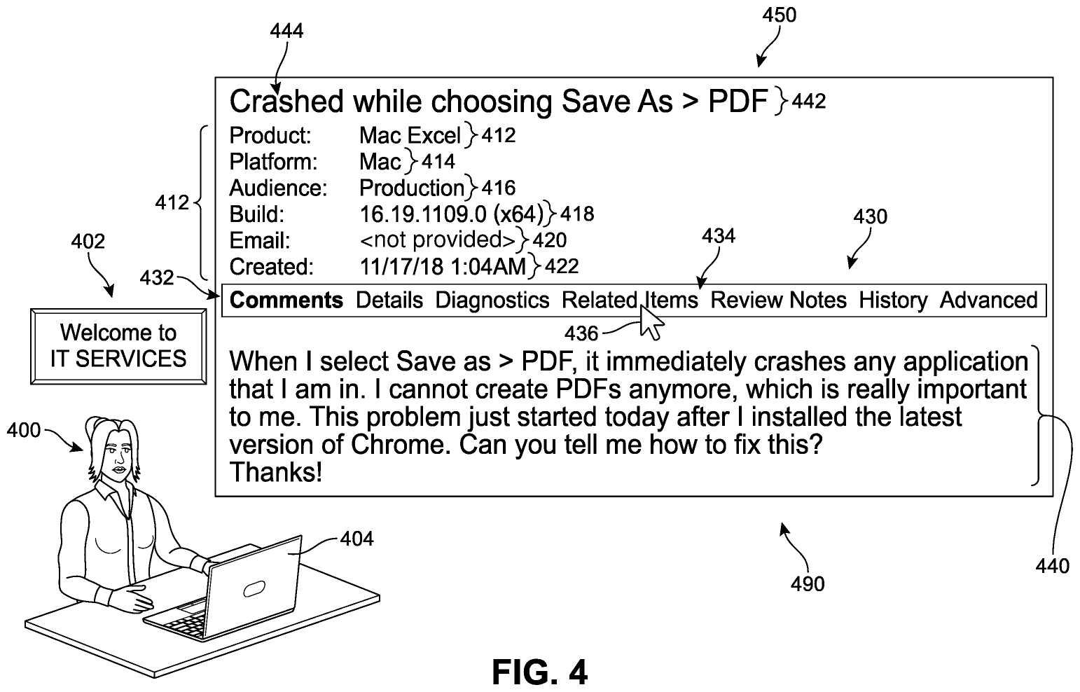

Referring next to FIG. 4, a reviewer 400 is depicted reviewing the contents of a reported message 450 submitted by the end-user 300 of FIGS. 3A and 3B. The reviewer 400 can, for example, be a member of an information technology team 402 for the vendor site, or a developer, personnel, or other individual whose role coincides with access to such messages. In different implementations, an interface presented via a display associated with reviewer's computing device 404 may be configured to present various icons, interfaces, graphics, applications, or other status information. As an example, the display includes an implementation of a message viewing interface (“interface”) 490 for the opening or accessing of a message.

In general, an “interface” can be understood to refer to a mechanism for communicating content through a client application to an application user. For example, interfaces may include pop-up windows that may be presented to a user via native application user interfaces (UIs), controls, actuatable interfaces, interactive buttons or other objects that may be shown to a user through native application UIs, as well as mechanisms that are native to a particular application for presenting associated content with those native controls. Furthermore, an “actuation” or “actuation event” refers to an event (or specific sequence of events) associated with a particular input or use of an application via an interface, which can trigger a change in the display of the application.

In addition, a “native control” refers to a mechanism for communicating content through a client application to an application user. For example, native controls may include actuatable or selectable options or “buttons” that may be presented to a user via native application UIs, touch-screen access points, menus items, or other objects that may be shown to a user through native application UIs, segments of a larger interface, as well as mechanisms that are native to a particular application for presenting associated content with those native controls. The term “asset” refers to content that may be presented in association with a native control in a native application. Thus, as non-limiting examples, an asset may include text in an actuatable pop-up window, audio associated with the interactive click of a button or other native application object, video associated with a teaching user interface, or other such information presentation.

As computing device 404 displays message 450 via interface 490 to the reviewer 400, she may in some implementations, be presented with multiple aspects or elements of the message, automatically classified or categorized to facilitate the evaluation of message 450. Generally, the stages of an interaction event from a reviewer can include opening or otherwise accessing the message, viewing or scrolling through specific portions of the message content, clicking or repositioning the location of the cursor (e.g., via a mouse) within the content, providing input, interacting with menu options associated with the message, and/or adjusting the view of the message contents.

As an example, the message 450 of FIG. 4 includes a subject line 442, a metadata section 412, and a message content 440 (“When I select Save as >PDF, it immediately crashes any application that I am in. I cannot create PDFs anymore, which is really important to me. This problem just started today after I installed the latest version of Chrome. Can you tell me how to fix this? Thanks!”). The message 450 in FIG. 4 is shown for purposes of illustration only, and it should be understood that viewed messages may vary widely from the arrangement and elements depicted. In other implementations, elements shown may be omitted, and/or additional elements may be included.

In this example, the subject line 442 comprises a text-based content 444 indicating “Crashed while choosing Save As >PDF”. In addition, a first metadata item 412 identifies the software product corresponding to the error as “Mac Excel”, a second metadata item 414 identifies the platform through which the software was running as “Mac”, a third metadata item 416 identifies the audience for the message as “Production”, a fourth metadata item 418 identifies the build of the device in which the error or operational event occurred as “16.19.1109.0 (x64), a fifth metadata item 420 could identify the username or email account for the user who submitted the message, and a sixth metadata item 422 identifies the time at which the message was submitted or created, here “11/17/18 1:04 AM”.

In different implementations, once reviewer 400 accesses the interface 490, the reviewer 400 may be able to view elements described above, as well as additional options or tools that can be used in association with the message contents. In some implementations, a toolbar 430 can be offered to the reviewer 400, comprising a plurality of options or settings for interacting with and further processing or addressing the message. In this case, for purposes of example only, the toolbar 430 includes options such as “Comments” (referring to the message contents), “Details”, “Diagnostics”, “Related Items”, “Review Notes”, “History”, and “Advanced”. In FIG. 4, the Comments option has been selected, or is presented by default, corresponding to a first option 432.

As reviewer 400 engages with interface 490, she may scroll through or otherwise access various portions of the displayed information. In some implementations, she may navigate over or otherwise select one of the proffered options of toolbar 430. In this example, a mouse cursor 436 is positioned to select a second option 434 (“Related Items”). In this case, Related Items refers generally to a user input or request to initiate an automated query and display of other messages available that are similar to the currently viewed message 450. It can be appreciated that in some implementations, the message content being used as the point of reference or ‘original’ message for which related feedback is being sought can be more narrowly defined by a reviewer. For example, the reviewer may select one sentence or other portion of the message content based upon which the system should perform its automated query.

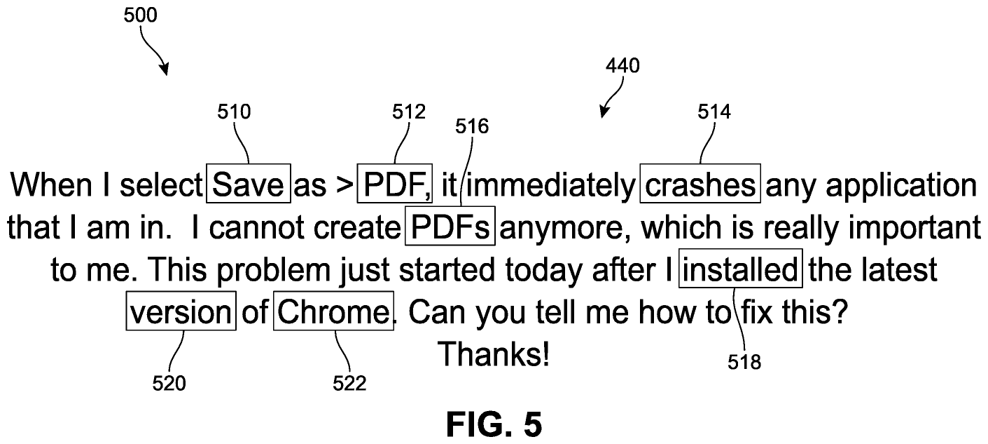

In different implementations, in response to a user selection (or as a default aspect of the user interface), a query can be automatically generated and executed, and related feedback displayed. One example of such a process is shown with reference to FIGS. 5-7. In FIG. 5, for purposes of clarity, the message content 440 is presented in isolation. It can be appreciated that message content 440 includes a plurality of terms 500, comprising the sentences of the feedback. In some implementations, the system can be configured to detect ‘key’ terms from this plurality of terms. In this example, a set of six terms are selected or designated as key terms, including a first term 510 (“Save”), a second term 512 (“PDF”), a third term 514 (“crashes”), a fourth term 516 (“PDFs”), a fifth term 518 (“installed”), a sixth term 520 (“version”), and a seventh term 522 (“Chrome”). These terms may be selected or identified by exclusion of non-substantive words or connecting language. It should be understood that the process of designating key terms as shown herein is can occur in conjunction with the metrics generator, as extraneous words or words that appear in a high number of messages are removed or ranked lowest.

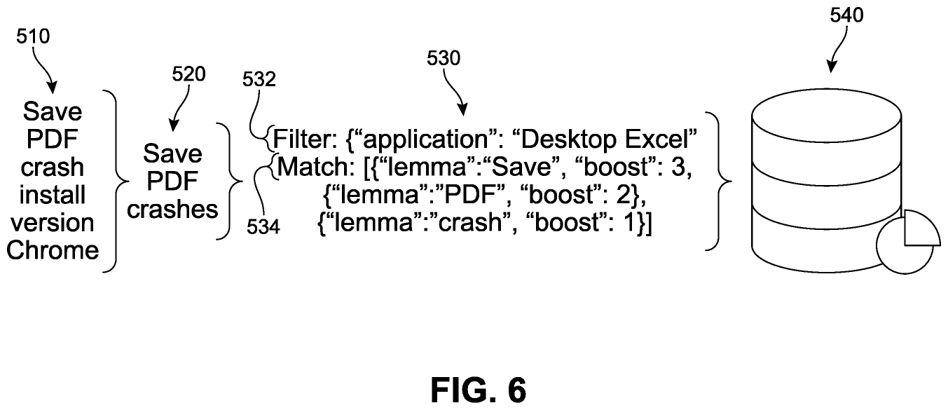

In FIG. 6, a schematic flow diagram of the query generation is depicted. At the left-most portion, the key terms of FIG. 5 are shown, representing a lemmatized plurality of terms 510, here including “Save, PDF, crash, install, version, Chrome”). These top-ranked ‘primary terms’ 520 are selected following processing or use of a computational technique (see metric generator of FIG. 2) are shown next. In some implementations, the primary terms 520 can be listed in order of their relative ranking following the application of one of the metric approaches. In a next stage, a query 530 is automatically generated based on the primary terms 520, as well as any selected or designated filters. In this case, the query includes a filter 532 that is configured to restrict the message corpus to only those messages directed to the Desktop Excel application. Furthermore, a plurality of query parameters or match terms are listed, including a first match term corresponding to a search for any word associated with a lemma “Save”, a second match term corresponding to a search for any word associated with a lemma “PDF”, and a third match term corresponding to a search for any word associated with a lemma “crash”. In some implementations, the match terms can also be assigned a ‘boost’ or order of importance in the search. In FIG. 6, because the term “Save” was determined to be of greatest significance in the message content, and thereby allocated the largest weight, and so is now assigned the highest (first) boost of 3. Similarly, the term “PDF” was determined to be of second greatest significance in the message content, allocated the second-largest weight, and is now assigned a second-level boost of 2. Finally, the term “Crash” was determined to be third ranked in significance to the message content, allocated the third-largest weight, and is now assigned a third-level boost of 3. The query 530 is executed with reference to a message corpus 540 that corresponds to the messages remaining after application of any filter(s).

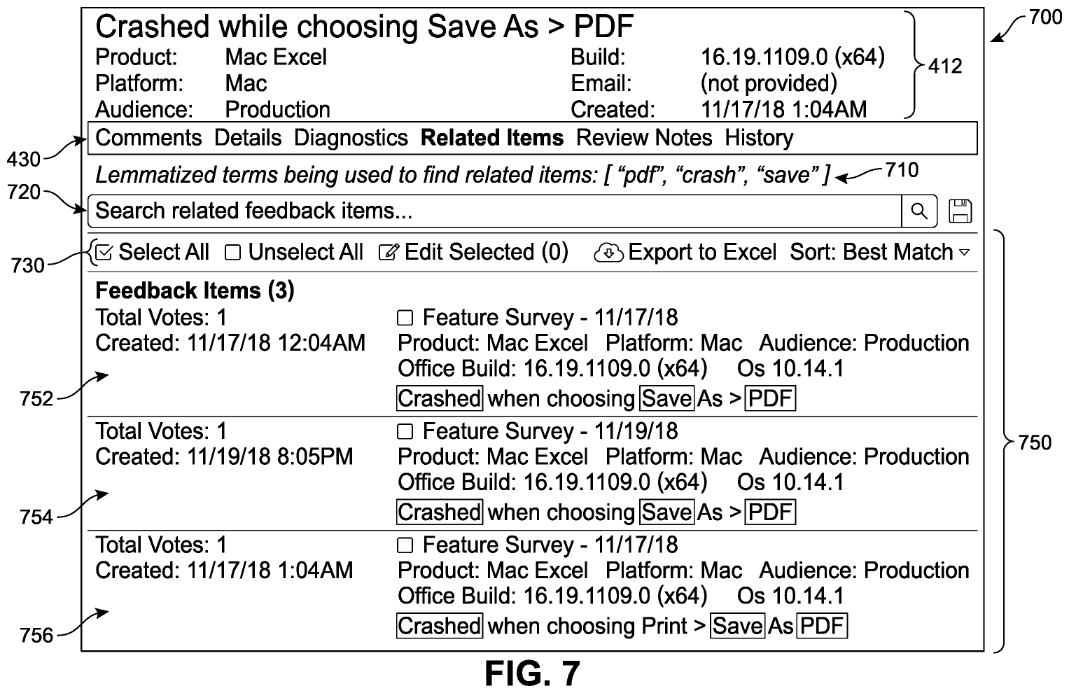

Referring now to FIG. 7, one implementation of a search results interface 750 is presented in the context of a main interface 700 that can include a similar arrangement as the previous message viewing interface 490 of FIG. 4, including (for example) the metadata section 412 (corresponding to the original message) and toolbar 430, and/or other items that may be of help in orienting the reviewer as they access the new information. As the query is automatically generated and executed, if any matches are found in the database, they may be automatically displayed to the user in the search results interface 750. In this case, three results were obtained, including a first message event 752, a second message event 754, and a third message event 756. As described earlier, in some implementations, these results can be listed in order of their calculated degree of similarity, or can be sorted by date, modifier, or other options custom selected by a user (see results toolbar 730). For example, some options include a “Select All” option (to select all messages listed), an “Unselect All” to undo the previous option, an option to “Edit Selected” messages, another option to “Export to Excel” for further message content and data manipulation, as well as a “Sort: [drop down]” option configured to allow the user to choose the order by which information is presented (here they are sorted by best match).

In some implementations, the system can be configured to provide option(s) that permit a user to view additional or other message events or properties that are currently hidden or not immediately shown on the default or initial display. As one example, a user selection or a movement of the cursor and/or hovering of the mouse over a message event representation indicator can lead to another, more detailed message, about the event or the properties being shown, for example, in a new window, or in a text box extending outward from the indicator, or an expanding segment adjacent to the listed message event. In another implementation, a user input can lead to a listing of other (additional) message events that may have been deemed somewhat relevant but less relevant than those being initially shown.

In different implementations, the message events being shown in the search results interface 750 can offer a broad overview of the properties of the related feedback item. For example, in FIG. 7, each message event includes identification of the product, platform, audience, office build, operating system (OS), and subject header of the message, as well as the reporting date of the message. In some implementations, other information can also be shown. Although the message content for each message event is not shown here, in other implementations, some or all of the message content for one or more messages may also be provided during presentation of the results. In addition, in some implementations, the reviewer may be able to access responses or actions that were taken with respect to one or more of the resultant messages. This can increase efficiency, as reviewers need not engage in redundant troubleshooting if the issue had been previously addressed or solved in response to a similar feedback from another time.

In addition, in some implementations, the system can include provisions by which a reviewer can be offered mechanisms by which to review the search parameters or query terms. For example, a query summary 710 is (“Lemmatized terms being used to find related items: [“choose”, “pdf”, “crash”, “save”]”) that informs the reviewer what terms were submitted for this query is provided. In some other implementations, the system can be configured to facilitate additional searches within the listed results, as represented by a search field 720 (“Search related feedback items”), which can be particularly useful when a large number of results are located and being presented to help a reviewer quickly narrow the results to a preferred type or content.

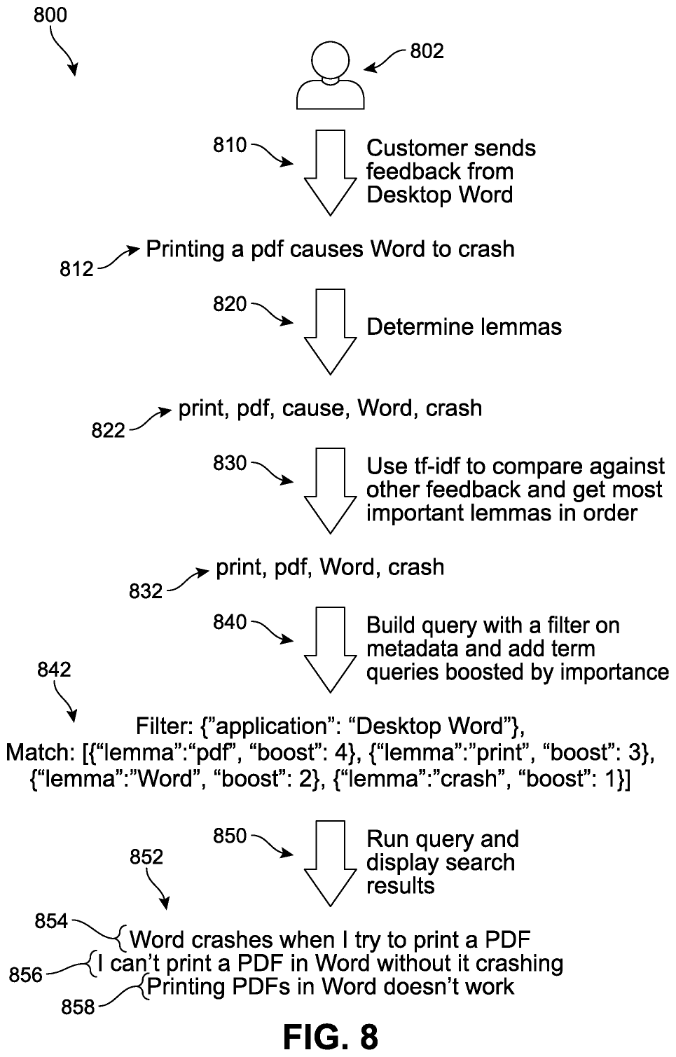

In order to allow the reader to better appreciate some of the aspects described herein, FIG. 8 presents a flow diagram of one implementation of a message content management system. In a first stage 810 (“Customer sends feedback from Desktop Word”), a user 802 may generate a message event, which will be received by the system. The message event in this example describes an operational issue summary 812 stating “Printing a pdf causes Word to crash”. At a second stage 820 (“Determine lemmas”), the message content is parsed and the plurality of terms are lemmatized. In this specific example, resulting lemmatized terms 822 include “print, pdf, cause, word, crash”.

In a third stage 830 (“Use tf-idf to compare against other feedback and get most important lemmas in order”) the system can process the lemmatized terms to determine their respective significance for the message event. Those terms that are deemed most relevant against the backdrop of other messages that have been received will be selected (here, “print, pdf, Word, and crash” comprise a set of primary terms 832 for use by the query generator). In a fourth stage 840 (“Build query with a filter on metadata and add term queries boosted by importance”), the system can automatically generate the query with reference to the primary terms 832 as well as any selected filters. The weight assigned to each primary term (indicating its relative importance) can also, in some implementations, be incorporated by the query builder to more specifically direct the search. In this case, a query 842 as shown in FIG. 8 includes ‘Filter: {application: Desktop Word}, Match: [{lemma, pdf, boost: 4}, {lemma, print, boost: 3}, {lemma, Word, boost: 2}, {lemma, crash, boost: 1}]. Thus, the query 842 will search only those messages associated with the Desktop Word application, and attempt to find matches based on the specified terms and their respective ranking (boost).

In a fifth stage 850 (“Run query and display search results”), the system can execute the query and determine if there are any matches. These matches 852 can then be displayed to the reviewer. In this case, three matches 852 corresponding to three related messages are identified, including a first match 854 (“Word crashes when I try to print a PDF”), a second match 856 (“I can't print a PDF in Word without it crashing”), and a third match 858 (“Printing PDFs in Word doesn't work”).

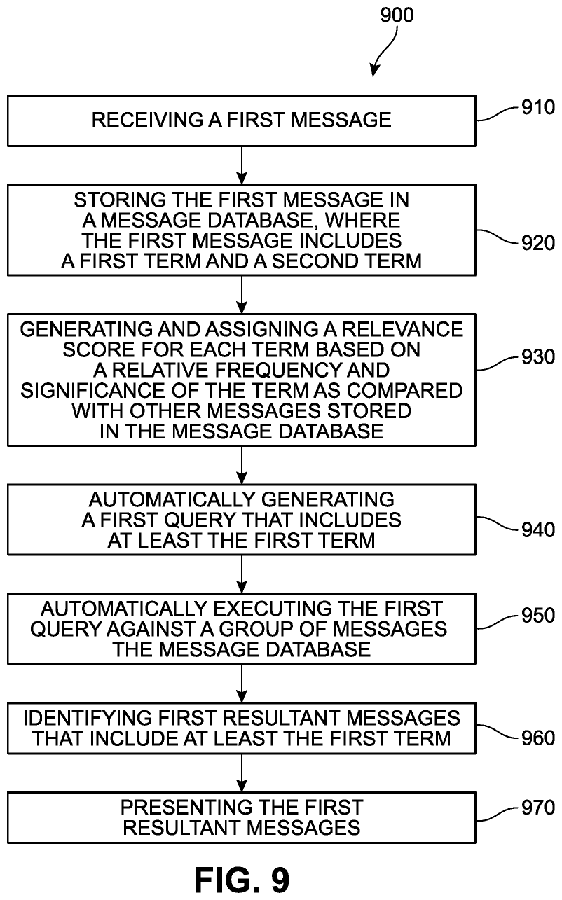

FIG. 9 is a flow chart illustrating an implementation of a method 900 of automatically searching for and presenting feedback related to a first message. A first step 910 includes receiving (from a first client system) a first message for an operational event or issue. A second step 920 includes storing the first message in a message database. In some implementations, the message database includes a plurality of messages. Each message in the message database can be understood to include its own set of terms. In this case, the set of terms for the first message includes at least a first term and a second term. A third step 930 involves generating a relevance score for each term and assigning this relevance score to said term in the first message. The relevance score is based on at least a relative frequency and significance of the term as compared with the set of terms for other messages stored in the message database. In this case, the first term is assigned a greater relevance score than the second term. A fourth step 940 includes composing or generating a first query that includes at least the first term, and a fifth step 950 includes automatically executing the first query against a group of messages in the message database. A sixth step 960 involves identifying (based at least on the first query) one or more first resultant messages of the group of messages that include at least the first term (if any are available). In this case, the first resultant messages includes at least a second message. Finally, in a seventh step 970, the method include presenting, via a display associated with a second client system, the first resultant messages, including the second message.

In other implementations, the method may include additional steps or aspects. As one example, the method may further include receiving, from a third client system, a third message, and then storing the third message in a message database. In this case, the set of terms for the third message include at least a third term, a fourth term, and a fifth term. Furthermore, the method then includes generating a relevance score for each term and then assigning this score to each term in the third message. In this case, the third term is assigned a greater relevance score than the fourth term, and the fourth term is assigned a greater relevance score than the fifth term (i.e., the third term has the highest score, and the fifth term has the lowest score). The method can further include composing a second query that includes only the third term and the fourth term, and then automatically executing the second query against the group of messages in the message database. In addition the method can include identifying, based on the second query, second resultant messages in the group of messages that include the third term and the fourth term, the second resultant messages including the first message, and subsequently presenting, via a display associated with a second client system, the second resultant messages.

As another example, in some implementations, the method also includes receiving, from the second client device, a request to view related feedback. In this case, the generating and assigning of the relevance score occurs automatically in response to receiving the request. In one implementation, the first resultant messages also include a third message, and the method can further involve presenting the third message (via the display). In some other implementations, the method includes calculating a frequency-inverse document frequency (TF-IDF) score for each term in the first message, where generating a relevance score for each term in the first message is based at least in part on the term's calculated TF-IDF score.

In different implementations, filters may also be part of the query and/or be applied during the query execution. For example, when the first message is associated with a first software product type, the method may further include automatically applying, prior to executing the first query, a first filter to the plurality of messages directed to the first software product type, and then limiting, in response to applying the first filter, the group of messages to include only messages also associated with the first software product type. As another example, when the first software product type is associated with a first version of the software (or first version label), the method may also include automatically applying, prior to executing the first query, a second filter to the plurality of messages directed to the first version label, and then limiting, in response to applying the second filter, the group of messages to include only messages also associated with the first version label of the first software product type. In a third example, when the first client system is associated with a first operating system type, the method may also involve automatically applying, prior to executing the first query, a filter to the plurality of messages directed to the first operating system type, and also limiting, in response to applying the filter, the group of messages to include only messages also received from a client system associated with the first operating system.

Furthermore, in some implementations, the first message can also include metadata identifying a creation date on which the first message was created or reported, and the method further includes limiting the group of messages to only include messages created within a pre-specified duration before or after the creation date. In another implementation, the third message is more closely related to the first message than the second message, and the third message is presented above the second message (e.g., results sorted by Best Match). In some implementations, the first term (as well as all of the terms being used in the query) can be lemmatized prior to execution of the first query. As a consequence, a presence of the first term in each of the first resultant messages is determined by reference to any term that is a natural language extension of the lemmatized first term.

Implementations of the present disclosure can make use of any of the features, systems, components, devices, and methods described in U.S. Patent Publication Number 2005/0097516 to Donnelly et al., published May 5, 2005 and titled “Extensible and dynamically-configurable problem-reporting client”; U.S. Pat. No. 7,571,150 to Raghavan et al., issued Aug. 4, 2009 and titled “Requesting, obtaining, and processing operational event feedback from customer data centers”; U.S. Patent Publication Number 2007/0027830 to Simons et al., published Feb. 1, 2007 and titled “Dynamic content development based on user feedback” the disclosures of each of which are herein incorporated by reference in their entirety.

The detailed examples of systems, devices, and techniques described in connection with FIGS. 1-9 are presented herein for illustration of the disclosure and its benefits. Such examples of use should not be construed to be limitations on the logical process implementations of the disclosure, nor should variations of user interface methods from those described herein be considered outside the scope of the present disclosure. In some implementations, various features described in FIGS. 1-9 are implemented in respective modules, which may also be referred to as, and/or include, logic, components, units, and/or mechanisms. Modules may constitute either software modules (for example, code embodied on a machine-readable medium) or hardware modules.

In some examples, a hardware module may be implemented mechanically, electronically, or with any suitable combination thereof. For example, a hardware module may include dedicated circuitry or logic that is configured to perform certain operations. For example, a hardware module may include a special-purpose processor, such as a field-programmable gate array (FPGA) or an Application Specific Integrated Circuit (ASIC). A hardware module may also include programmable logic or circuitry that is temporarily configured by software to perform certain operations, and may include a portion of machine-readable medium data and/or instructions for such configuration. For example, a hardware module may include software encompassed within a programmable processor configured to execute a set of software instructions. It will be appreciated that the decision to implement a hardware module mechanically, in dedicated and permanently configured circuitry, or in temporarily configured circuitry (for example, configured by software) may be driven by cost, time, support, and engineering considerations.

Accordingly, the phrase “hardware module” should be understood to encompass a tangible entity capable of performing certain operations and may be configured or arranged in a certain physical manner, be that an entity that is physically constructed, permanently configured (for example, hardwired), and/or temporarily configured (for example, programmed) to operate in a certain manner or to perform certain operations described herein. As used herein, “hardware-implemented module” refers to a hardware module. Considering examples in which hardware modules are temporarily configured (for example, programmed), each of the hardware modules need not be configured or instantiated at any one instance in time. For example, where a hardware module includes a programmable processor configured by software to become a special-purpose processor, the programmable processor may be configured as respectively different special-purpose processors (for example, including different hardware modules) at different times. Software may accordingly configure a particular processor or processors, for example, to constitute a particular hardware module at one instance of time and to constitute a different hardware module at a different instance of time. A hardware module implemented using one or more processors may be referred to as being “processor implemented” or “computer implemented.”

Hardware modules can provide information to, and receive information from, other hardware modules. Accordingly, the described hardware modules may be regarded as being communicatively coupled. Where multiple hardware modules exist contemporaneously, communications may be achieved through signal transmission (for example, over appropriate circuits and buses) between or among two or more of the hardware modules. In implementations in which multiple hardware modules are configured or instantiated at different times, communications between such hardware modules may be achieved, for example, through the storage and retrieval of information in memory devices to which the multiple hardware modules have access. For example, one hardware module may perform an operation and store the output in a memory device, and another hardware module may then access the memory device to retrieve and process the stored output.

In some examples, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by, and/or among, multiple computers (as examples of machines including processors), with these operations being accessible via a network (for example, the Internet) and/or via one or more software interfaces (for example, an application program interface (API)). The performance of certain of the operations may be distributed among the processors, not only residing within a single machine, but deployed across a number of machines. Processors or processor-implemented modules may be located in a single geographic location (for example, within a home or office environment, or a server farm), or may be distributed across multiple geographic locations.

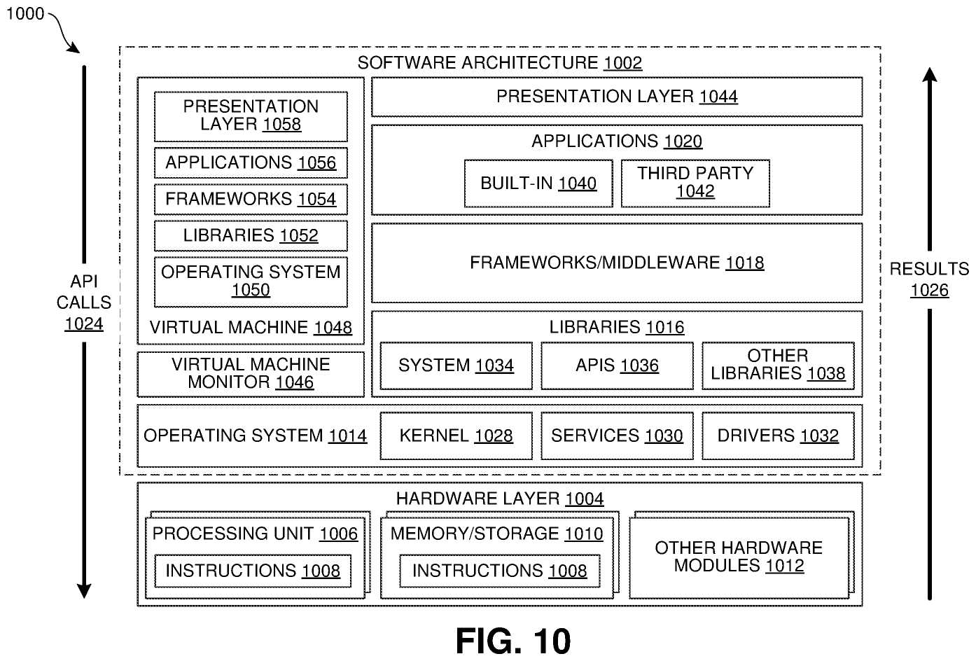

FIG. 10 is a block diagram 1000 illustrating an example software architecture 1002, various portions of which may be used in conjunction with various hardware architectures herein described, which may implement any of the above-described features. FIG. 10 is a non-limiting example of a software architecture and it will be appreciated that many other architectures may be implemented to facilitate the functionality described herein. The software architecture 1002 may execute on hardware such as a device 120 of FIG. 1A that includes, among other things, document storage 1070, processors, memory, and input/output (I/O) components. A representative hardware layer 1004 is illustrated and can represent, for example, the device 120 of FIG. 1. The representative hardware layer 1004 includes a processing unit 1006 and associated executable instructions 1008. The executable instructions 1008 represent executable instructions of the software architecture 1002, including implementation of the methods, modules and so forth described herein. The hardware layer 1004 also includes a memory/storage 1010, which also includes the executable instructions 1008 and accompanying data. The hardware layer 1004 may also include other hardware modules 1012. Instructions 1008 held by processing unit 1008 may be portions of instructions 1008 held by the memory/storage 1010.

The example software architecture 1002 may be conceptualized as layers, each providing various functionality. For example, the software architecture 1002 may include layers and components such as an operating system (OS) 1014, libraries 1016, frameworks 1018, applications 1020, and a presentation layer 1044. Operationally, the applications 1020 and/or other components within the layers may invoke API calls 1024 to other layers and receive corresponding results 1026. The layers illustrated are representative in nature and other software architectures may include additional or different layers. For example, some mobile or special purpose operating systems may not provide the frameworks/middleware 1018.

The OS 1014 may manage hardware resources and provide common services. The OS 1014 may include, for example, a kernel 1028, services 1030, and drivers 1032. The kernel 1028 may act as an abstraction layer between the hardware layer 1004 and other software layers. For example, the kernel 1028 may be responsible for memory management, processor management (for example, scheduling), component management, networking, security settings, and so on. The services 1030 may provide other common services for the other software layers. The drivers 1032 may be responsible for controlling or interfacing with the underlying hardware layer 1004. For instance, the drivers 1032 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 1016 may provide a common infrastructure that may be used by the applications 1020 and/or other components and/or layers. The libraries 1016 typically provide functionality for use by other software modules to perform tasks, rather than rather than interacting directly with the OS 1014. The libraries 1016 may include system libraries 1034 (for example, C standard library) that may provide functions such as memory allocation, string manipulation, file operations. In addition, the libraries 1016 may include API libraries 1036 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 1016 may also include a wide variety of other libraries 1038 to provide many functions for applications 1020 and other software modules.

The frameworks 1018 (also sometimes referred to as middleware) provide a higher-level common infrastructure that may be used by the applications 1020 and/or other software modules. For example, the frameworks 1018 may provide various graphic user interface (GUI) functions, high-level resource management, or high-level location services. The frameworks 1018 may provide a broad spectrum of other APIs for applications 1020 and/or other software modules.

The applications 1020 include built-in applications 1040 and/or third-party applications 1042. Examples of built-in applications 1040 may include, but are not limited to, a contacts application, a browser application, a location application, a media application, a messaging application, and/or a game application. Third-party applications 1042 may include any applications developed by an entity other than the vendor of the particular platform. The applications 1020 may use functions available via OS 1014, libraries 1016, frameworks 1018, and presentation layer 1044 to create user interfaces to interact with users.

Some software architectures use virtual machines, as illustrated by a virtual machine 1048. The virtual machine 1048 provides an execution environment where applications/modules can execute as if they were executing on a hardware machine (such as the machine 1000 of FIG. 10, for example). The virtual machine 1048 may be hosted by a host OS (for example, OS 1014) or hypervisor, and may have a virtual machine monitor 1046 which manages operation of the virtual machine 1048 and interoperation with the host operating system. A software architecture, which may be different from software architecture 1002 outside of the virtual machine, executes within the virtual machine 1048 such as an OS 1050, libraries 1052, frameworks 1054, applications 1056, and/or a presentation layer 1058.

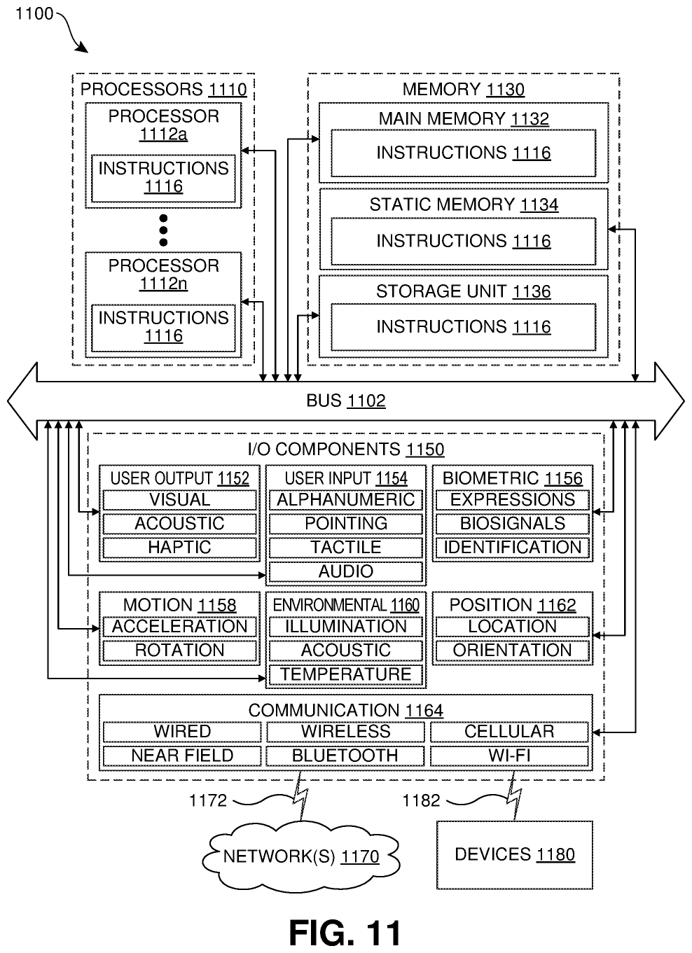

FIG. 11 is a block diagram illustrating components of an example machine 1100 configured to read instructions from a machine-readable medium (for example, a machine-readable storage medium) and perform any of the features described herein. The example machine 1100 is in a form of a computer system, within which instructions 1116 (for example, in the form of software components) for causing the machine 1100 to perform any of the features described herein may be executed. As such, the instructions 1116 may be used to implement modules or components described herein. The instructions 1116 cause unprogrammed and/or unconfigured machine 1100 to operate as a particular machine configured to carry out the described features. The machine 1100 may be configured to operate as a standalone device or may be coupled (for example, networked) to other machines. In a networked deployment, the machine 1100 may operate in the capacity of a server machine or a client machine in a server-client network environment, or as a node in a peer-to-peer or distributed network environment. Machine 1100 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 1100 is illustrated, the term “machine” include a collection of machines that individually or jointly execute the instructions 1116.

The machine 1100 may include processors 1110, memory 1130, and I/O components 1150, which may be communicatively coupled via, for example, a bus 1102. The bus 1102 may include multiple buses coupling various elements of machine 1100 via various bus technologies and protocols. In an example, the processors 1110 (including, for example, a central processing unit (CPU), a graphics processing unit (GPU), a digital signal processor (DSP), an ASIC, or a suitable combination thereof) may include one or more processors 1112a to 1112n that may execute the instructions 1116 and process data. In some examples, one or more processors 1110 may execute instructions provided or identified by one or more other processors 1110. The term “processor” includes a multi-core processor including cores that may execute instructions contemporaneously. Although FIG. 11 shows multiple processors, the machine 1100 may include a single processor with a single core, a single processor with multiple cores (for example, a multi-core processor), multiple processors each with a single core, multiple processors each with multiple cores, or any combination thereof. In some examples, the machine 1100 may include multiple processors distributed among multiple machines.

The memory/storage 1130 may include a main memory 1132, a static memory 1134, or other memory, and a storage unit 1136, both accessible to the processors 1110 such as via the bus 1102. The storage unit 1136 and memory 1132, 1134 store instructions 1116 embodying any one or more of the functions described herein. The memory/storage 1130 may also store temporary, intermediate, and/or long-term data for processors 1110. The instructions 1116 may also reside, completely or partially, within the memory 1132, 1134, within the storage unit 1136, within at least one of the processors 1110 (for example, within a command buffer or cache memory), within memory at least one of I/O components 1150, or any suitable combination thereof, during execution thereof. Accordingly, the memory 1132, 1134, the storage unit 1136, memory in processors 1110, and memory in I/O components 1150 are examples of machine-readable media.

As used herein, “machine-readable medium” refers to a device able to temporarily or permanently store instructions and data that cause machine 1100 to operate in a specific fashion. The term “machine-readable medium,” as used herein, does not encompass transitory electrical or electromagnetic signals per se (such as on a carrier wave propagating through a medium); the term “machine-readable medium” may therefore be considered tangible and non-transitory. Non-limiting examples of a non-transitory, tangible machine-readable medium may include, but are not limited to, nonvolatile memory (such as flash memory or read-only memory (ROM)), volatile memory (such as a static random-access memory (RAM) or a dynamic RAM), buffer memory, cache memory, optical storage media, magnetic storage media and devices, network-accessible or cloud storage, other types of storage, and/or any suitable combination thereof. The term “machine-readable medium” applies to a single medium, or combination of multiple media, used to store instructions (for example, instructions 1116) for execution by a machine 1100 such that the instructions, when executed by one or more processors 1110 of the machine 1100, cause the machine 1100 to perform and one or more of the features described herein. Accordingly, a “machine-readable medium” may refer to a single storage device, as well as “cloud-based” storage systems or storage networks that include multiple storage apparatus or devices.

The I/O components 1150 may include a wide variety of hardware components adapted to receive input, provide output, produce output, transmit information, exchange information, capture measurements, and so on. The specific I/O components 1150 included in a particular machine will depend on the type and/or function of the machine. For example, mobile devices such as mobile phones may include a touch input device, whereas a headless server or IoT device may not include such a touch input device. The particular examples of I/O components illustrated in FIG. 11 are in no way limiting, and other types of components may be included in machine 1100. The grouping of I/O components 1150 are merely for simplifying this discussion, and the grouping is in no way limiting. In various examples, the I/O components 1150 may include user output components 1152 and user input components 1154. User output components 1152 may include, for example, display components for displaying information (for example, a liquid crystal display (LCD) or a projector), acoustic components (for example, speakers), haptic components (for example, a vibratory motor or force-feedback device), and/or other signal generators. User input components 1154 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 1150 may include biometric components 1156 and/or position components 1162, among a wide array of other environmental sensor components. The biometric components 1156 may include, for example, components to detect body expressions (for example, facial expressions, vocal expressions, hand or body gestures, or eye tracking), measure biosignals (for example, heart rate or brain waves), and identify a person (for example, via voice-, retina-, and/or facial-based identification). The position components 1162 may include, for example, location sensors (for example, a Global Position System (GPS) receiver), altitude sensors (for example, an air pressure sensor from which altitude may be derived), and/or orientation sensors (for example, magnetometers).

The I/O components 1150 may include communication components 1164, implementing a wide variety of technologies operable to couple the machine 1100 to network(s) 1170 and/or device(s) 1180 via respective communicative couplings 1172 and 1182. The communication components 1164 may include one or more network interface components or other suitable devices to interface with the network(s) 1170. The communication components 1164 may include, for example, components adapted to provide wired communication, wireless communication, cellular communication, Near Field Communication (NFC), Bluetooth communication, Wi-Fi, and/or communication via other modalities. The device(s) 1180 may include other machines or various peripheral devices (for example, coupled via USB).

In some examples, the communication components 1164 may detect identifiers or include components adapted to detect identifiers. For example, the communication components 1164 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 1162, such as, but not limited to, geo-location via Internet Protocol (IP) address, location via Wi-Fi, cellular, NFC, Bluetooth, or other wireless station identification and/or signal triangulation.

While various implementations have been described, the description is intended to be exemplary, rather than limiting, and it is understood that many more implementations and implementations are possible that are within the scope of the implementations. Although many possible combinations of features are shown in the accompanying figures and discussed in this detailed description, many other combinations of the disclosed features are possible. Any feature of any implementation may be used in combination with or substituted for any other feature or element in any other implementation unless specifically restricted. Therefore, it will be understood that any of the features shown and/or discussed in the present disclosure may be implemented together in any suitable combination. Accordingly, the implementations are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus the following claims are hereby incorporated into the Detailed Description, with each claim standing on its own as a separately claimed subject matter.

What is claimed is:

1. A data processing system comprising:
a processor; and
computer readable media including instructions which, when executed by the processor, cause the processor to:
receive, from a first client system, a first message;
store the first message in a message database, the message database including a plurality of messages, wherein each message in the message database includes its own set of terms, the set of terms for the first message including a first term and a second term;
generate and assign a relevance score for each term in the first message based on at least a relative frequency and significance of the term as compared with each set of terms for other messages stored in the message database, the first term being assigned a greater relevance score than the second term;
automatically compose a first query that includes at least the first term;
automatically execute the first query against a group of messages in the message database;
identify, based on the first query, first resultant messages of the group of messages that include at least the first term, the first resultant messages including a second message; and
present, via a display associated with a second client system, the first resultant messages, including the second message.

2. The system of claim 1, wherein the instructions further cause the processor to:
receive, from a third client system, a third message;
store the third message in a message database, the set of terms for the third message including a third term, a fourth term, and a fifth term;
generate and assign a relevance score for each term in the third message, the third term being assigned a greater relevance score than the fourth term, and the fourth term being assigned a greater relevance score than the fifth term;
automatically compose a second query that includes only the third term and the fourth term;
automatically execute the second query against the group of messages in the message database;
identify, based on the second query, second resultant messages in the group of messages that include the third term and the fourth term, the second resultant messages including the first message; and
present, via a display associated with a second client system, the second resultant messages.

3. The system of claim 1, wherein the instructions further cause the processor to receive, from the second client device, a request to view related feedback, wherein the generating and assigning of the relevance score occurs automatically in response to receiving the request.

4. The system of claim 1, wherein the first resultant messages also include a third message, and the method further comprises presenting the third message.

5. The system of claim 1, wherein the instructions further cause the processor to calculate a frequency-inverse document frequency (TF-IDF) score for each term in the first message, wherein generating a relevance score for each term in the first message is based on the term's calculated TF-IDF score.

6. The system of claim 1, wherein the first message is associated with a first software product type, and the instructions further cause the processor to:
automatically apply, prior to executing the first query, a first filter to the plurality of messages directed to the first software product type; and
limit, in response to applying the first filter, the group of messages to include only messages also associated with the first software product type.

7. The system of claim 6, wherein the first software product type is associated with a first version label, and the instructions further cause the processor to:
automatically apply, prior to executing the first query, a second filter to the plurality of messages directed to the first version label; and
limit, in response to applying the second filter, the group of messages to include only messages also associated with the first version label of the first software product type.

8. The system of claim 1, wherein the first client system is associated with a first operating system type, and the instructions further cause the processor to:
automatically apply, prior to executing the first query, a filter to the plurality of messages directed to the first operating system type; and
limit, in response to applying the filter, the group of messages to include only messages also received from a client system associated with the first operating system.

9. The system of claim 1, wherein the first message further includes metadata identifying a creation date on which the first message was created, and the instructions further cause the processor to limit the group of messages to only include messages created within a pre-specified duration before or after the creation date.

10. The system of claim 1, wherein the first term is lemmatized prior to execution of the first query, and a presence of the first term in each of the first resultant messages is determined by reference to any term that is an extension of the lemmatized first term.

11. A method of generating and presenting related information, the method comprising:
receiving, from a first client system, a first message;
storing the first message in a message database, the message database including a plurality of messages, wherein each message in the message database includes its own set of terms, the set of terms for the first message including a first term and a second term;
generating and assigning a relevance score for each term in the first message based on at least a relative frequency and significance of the term as compared with each set of terms for other messages stored in the message database, the first term being assigned a greater relevance score than the second term;
automatically composing a first query that includes at least the first term;
automatically executing the first query against a group of messages in the message database;
identifying, based on the first query, first resultant messages of the group of messages that include at least the first term, the first resultant messages including a second message; and
presenting, via a display associated with a second client system, the first resultant messages, including the second message.

12. The method of claim 11, further comprising:
receiving, from a third client system, a third message;
storing the third message in a message database, the set of terms for the third message including a third term, a fourth term, and a fifth term;
generating and assigning a relevance score for each term in the third message, the third term being assigned a greater relevance score than the fourth term, and the fourth term being assigned a greater relevance score than the fifth term;
automatically composing a second query that includes only the third term and the fourth term;
automatically executing the second query against the group of messages in the message database;
identifying, based on the second query, second resultant messages in the group of messages that include the third term and the fourth term, the second resultant messages including the first message; and
presenting, via a display associated with a second client system, the second resultant messages.

13. The method of claim 11, further comprising receiving, from the second client device, a request to view related feedback, wherein the generating and assigning of the relevance score occurs automatically in response to receiving the request.

14. The method of claim 11, wherein the first resultant messages also include a third message, and the method further comprises presenting the third message.

15. The method of claim 11, further comprising calculating a frequency-inverse document frequency (TF-IDF) score for each term in the first message, wherein generating a relevance score for each term in the first message is based on the term's calculated TF-IDF score.

16. The method of claim 11, wherein the first message is associated with a first software product type, and the method further comprises:
automatically applying, prior to executing the first query, a first filter to the plurality of messages directed to the first software product type; and
limiting, in response to applying the first filter, the group of messages to include only messages also associated with the first software product type.

17. The method of claim 16, wherein the first software product type is associated with a first version label, and the method further comprises:
automatically applying, prior to executing the first query, a second filter to the plurality of messages directed to the first version label; and
limiting, in response to applying the second filter, the group of messages to include only messages also associated with the first version label of the first software product type.

18. The method of claim 11, wherein the first client system is associated with a first operating system type, and the method further comprises:
automatically applying, prior to executing the first query, a filter to the plurality of messages directed to the first operating system type; and
limiting, in response to applying the filter, the group of messages to include only messages also received from a client system associated with the first operating system.

19. The method of claim 11, wherein the first message further includes metadata identifying a creation date on which the first message was created, and the method further comprises limiting the group of messages to only include messages created within a pre-specified duration before or after the creation date.

20. A computer readable medium including instructions stored therein which, when executed by a processor, cause the processor to perform operations comprising:
receive, from a first client system, a first message;
store the first message in a message database, the message database including a plurality of messages, wherein each message in the message database includes its own set of terms, the set of terms for the first message including a first term and a second term;
generate and assign a relevance score for each term in the first message based on at least a relative frequency and significance of the term as compared with the set of terms for other messages stored in the message database, the first term being assigned a greater relevance score than the second term;
automatically compose a first query that includes at least the first term;
automatically execute the first query against a group of messages in the message database;
identify, based on the first query, first resultant messages of the group of messages that include at least the first term, the first resultant messages including a second message; and
present, via a display associated with a second client system, the first resultant messages, including the second message.
